(19) United States
(12) Patent Application Publication
(10) Pub. No.: US 2008/0012175 A1
(43) Pub. Date: Jan. 17, 2008

(54) Method for making an acryl plate with an inner picture layer

(76) Inventor: Ping-Yuan Chiu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/484,784

(22) Filed: Jul. 12, 2006

(51) Int. Cl. B29C 45/14

(52) U.S. Cl. 264/279; 264/279.1

(57) ABSTRACT

A method for manufacturing an acryl plate includes injecting acryl material into a lower mold part of a mold to make a first acryl layer in the lower mold part, positioning a print on an upper side of the first acryl layer, positioning an upper mold part of the mold over the lower mold part, and injecting acryl material into the upper mold part to make a second acryl layer in the upper mold part as well as sandwiching the print between the first and the second acryl layers; the print is a cast coated Kraft paper, and has pictures thereon, which are printed with heat-resistant, easily fixable, light-resistant, and high temperature resistant ink, and which contain images of people, stories, things, and scenery.

### BACKGROUND OF THE INVENTION

1. Field of the Invention

The present invention relates to a method for manufacturing an acryl plate with an inner picture layer, according to which method a print having pictures printed on at least one side is sandwiched between first and second acryl layers of a finished acryl plate so as not to distort, stretch, shrink or change shape; the pictures contain images of people, stories, things, and scenery.

2. Brief Description of the Prior Art

Acryl materials are relatively strong, light in weight, and easy to machine, having many advantages, therefore they are getting popular, and take the place of plastic and glass gradually.

Early acryl materials were transparent. Afterwards, dyes were added in acryl raw materials to make different colored acryl products, which are more pleasant-looking than transparent ones. However, such acryl products each are single color therefore they aren't attractive enough. More recently, several different color dyes are added in acryl raw materials for making colorful acryl products. However, after different color dyes are added in acryl raw materials, they will mix with the raw materials very rapidly because the raw materials are liquid. Therefore, it is relatively difficult to make colorful acryl products whose appearance is exactly the same as expected. In other words, it is relatively difficult to make colorful acryl products of uniform quality by using the above method.

Currently, images are printed or pictures are stuck on transparent acryl products to make the acryl products more attractive. However, the printed images and pictures are prone to get damaged and fall off gradually owing to rubbing and washing.

### SUMMARY OF THE INVENTION

It is a main object of the invention to provide a method for manufacturing an acryl plate with an inner picture layer to overcome the above-mentioned problems. According to the method of the present invention, firstly acryl material is injected into a lower mold part of a mold to make a first acryl layer in the lower mold part, and secondly a print is positioned on an upper side of the first acryl layer, and thirdly an upper mold part of the mold is positioned over the lower mold part, and finally acryl material is injected into the upper mold part to make a second acryl layer as well as sandwiching the print between the first and the second acryl layers; the print is a cast coated Kraft paper, and has pictures thereon, which are printed with heat-resistant, easily fixable, light-resistant and high temperature resistant ink, and contain images of people, stories, things, and scenery. Therefore, the pictures have quality and attractive colors, which can't mix or fade, and the print can't distort, stretch, shrink or change shape, and there can't be crack forming on the ink and the print.

### BRIEF DESCRIPTION OF THE DRAWINGS

The present invention will be better understood by referring to the accompanying drawings, wherein:

FIG. 1 shows the first step of the manufacturing method in the present invention,

FIG. 2 shows the second step of the present manufacturing method,

FIG. 3 shows the third step of the present manufacturing method,

FIG. 4 shows the final step of the manufacturing method, and

FIG. 5 is a lateral sectional view of an acryl plate made according to the method of the present invention.

### DETAILED DESCRIPTION OF THE PREFERRED EMBODIMENTS

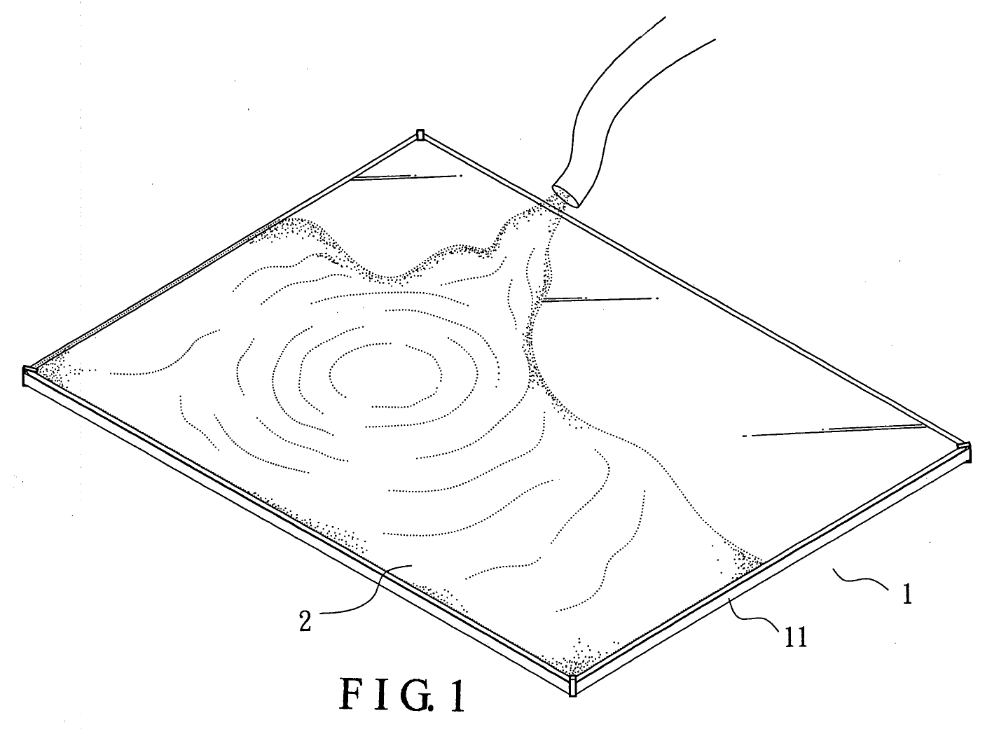

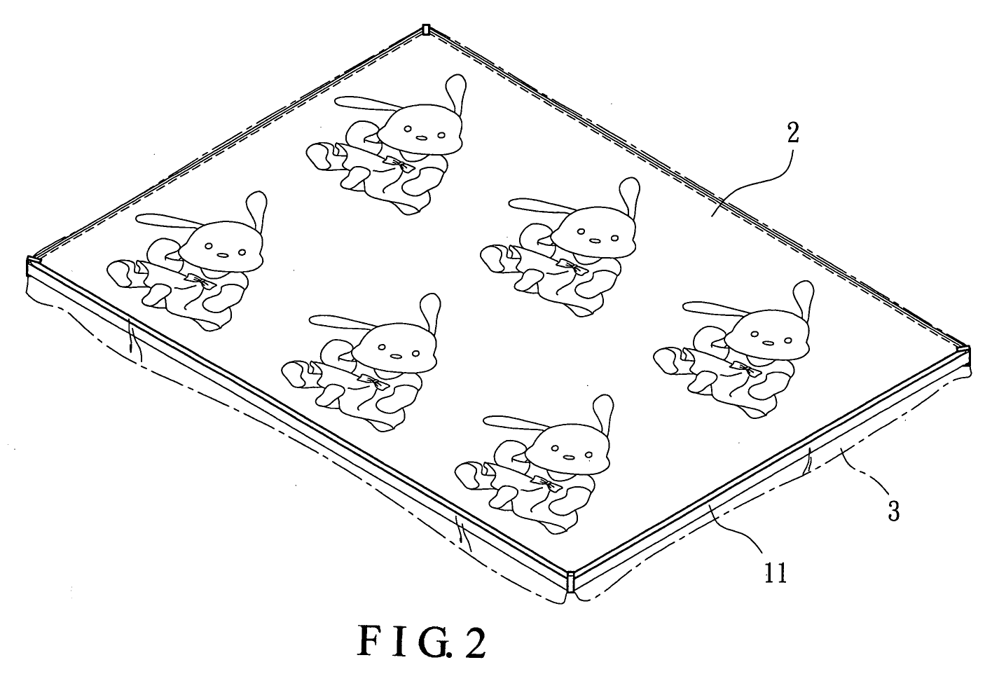

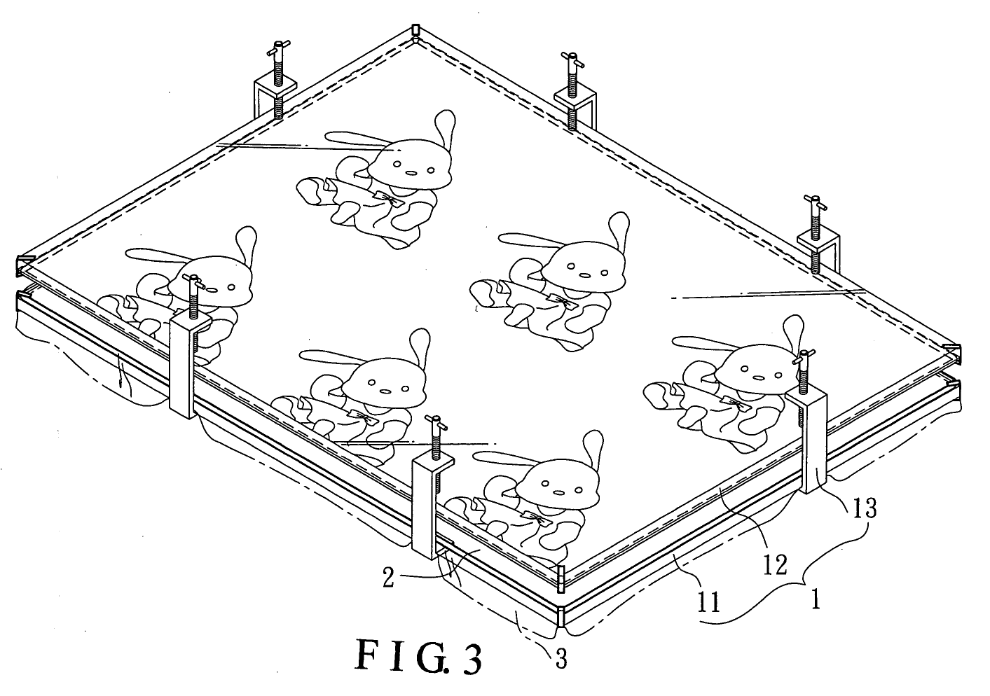

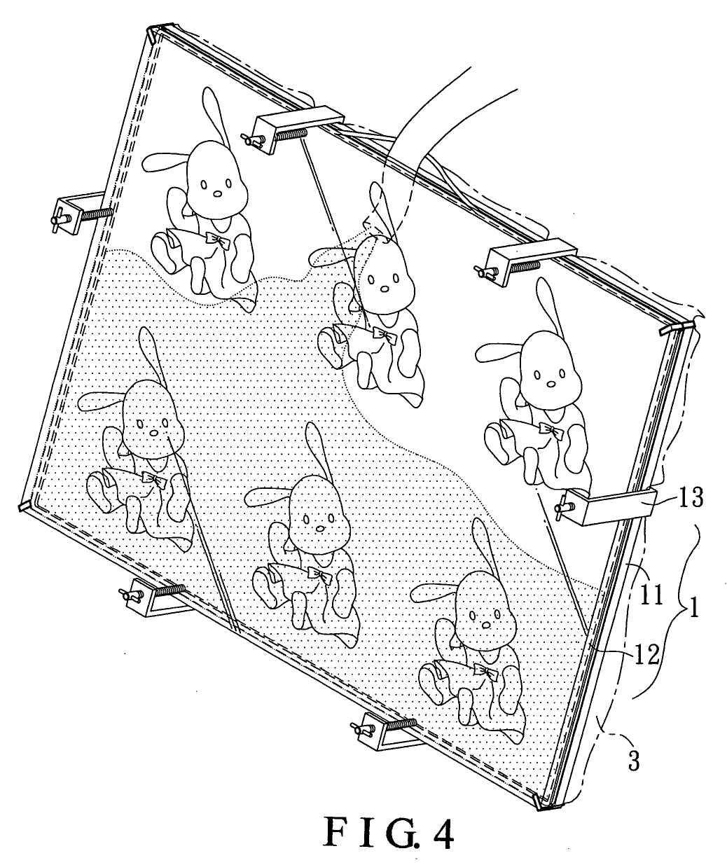

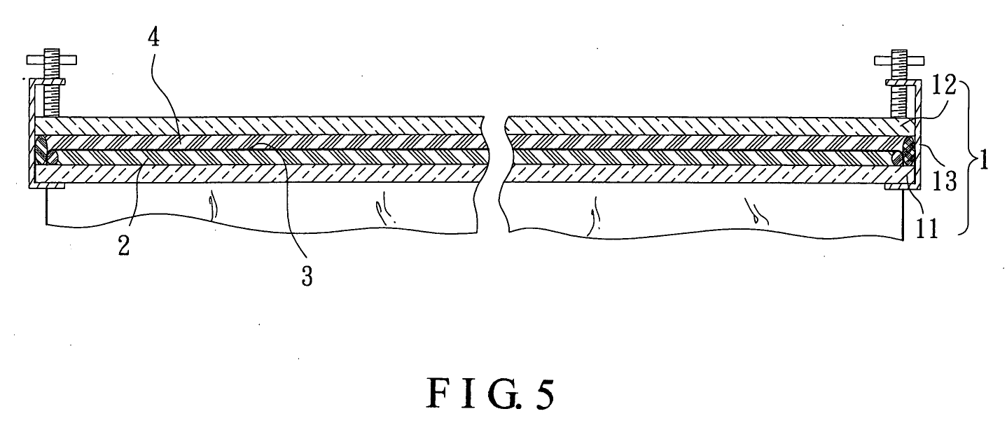

Referring to FIGS. 1 to 5, a preferred embodiment of a method for manufacturing an acryl plate with an inner picture layer includes the following steps:

injecting acryl material into a lower mold part 11 of a mold 1 to make a first acryl layer 2 in the lower mold part 11;

positioning a print 3 on an upper side of the first acryl layer 2; the print 3 is a cast coated Kraft paper, and has pictures printed on one side or both sides thereof; the pictures contain images of people, stories, things, scenery etc, and they are printed with heat-resistant, easily fixable, high temperature resistant and light-resistant ink;

positioning an upper mold part 12 of the mold 1 over the lower mold part 11, and holding the upper and the lower mold parts 12 and 11 firmly together by means of using fastening elements 13; thus, the upper and the lower mold parts 12 and 11 can't separate or move relative to each other; and

injecting acryl material into the upper mold part 12; thus, a second acryl layer 4 is formed in the upper mold part 12, and the print 3, which has the pictures containing people, stores, things, scenery, is sandwiched between the first and the second acryl layers 2 and 4.

Therefore, after the upper and the lower mold parts 12 and 11 are separated from the first and the second acryl layers 2 and 4, an acryl plate with the print 3 (an inner picture layer) is formed, which contains people, stories, things, scenery etc, and people can see the pictures on the print 3 (inner picture layer) through the first and the second acryl layers 2 and 4.

Because the print (inner picture layer) is a cast coated Kraft paper made of frigid zone fiber and has pictures printed on one side or both sides thereof, which pictures contain images of people, stories, things, scenery etc, and because heat-resistant, adhering, high temperature resistant and light-resistant ink is used for printing the pictures, the pictures have quality and attractive colors, which can't mix, fade or loss their brightness, and the print (inner picture layer) can't distort, stretch, shrink or change shape, and the ink and the print can't crack. Furthermore, the acryl plate will be even more attractive if the print (inner picture layer) has pictures on two sides thereof.

What is claimed is:

1. A method for manufacturing an acryl plate with an inner picture layer, comprising steps
(a) injecting acryl material into a lower mold part of a mold such that a first acryl layer is formed in the lower mold part;
(b) positioning a print on an upper side of the first acryl layer; the print being a cast coated Kraft paper having pictures printed thereon; heat-resistant, easily fixable, light-resistant and high temperature resistant ink being used for printing the pictures;
(c) positioning an upper mold part of the mold over the lower mold part; and
(d) injecting acryl material into the upper mold part such that a second acryl layer is formed in the upper mold part, and the print is sandwiched between the first and the second acryl layers.

2. The method for manufacturing an acryl plate with an inner picture layer as recited in claim 1, wherein the cast coated Kraft paper print has images of people printed thereon.

3. The method for manufacturing an acryl plate with an inner picture layer as recited in claim 1, wherein the cast coated Kraft paper print has images of stories printed thereon.

4. The method for manufacturing an acryl plate with an inner picture layer as recited in claim 1, wherein the cast coated Kraft paper print has images of things printed thereon.

5. The method for manufacturing an acryl plate with an inner picture layer as recited in claim 1, wherein the cast coated Kraft paper print has images of scenery printed thereon.

6. The method for manufacturing an acryl plate with an inner picture layer as recited in claim 1, wherein the upper and the lower mold parts are firmly held together by means of using a plurality of fastening elements.

7. The method for manufacturing an acryl plate with an inner picture layer as recited in claim 1, wherein the cast coated Kraft paper print has pictures printed on one side thereof.

8. The method for manufacturing an acryl plate with an inner picture layer as recited in claim 1, wherein the cast coated Kraft paper print has pictures printed on both sides thereof.
